(19) United States
(12) Patent Application Publication
(10) Pub. No.: US 2013/0120695 A1
(43) Pub. Date: May 16, 2013

(54) Tunable Flat-Top Liquid Crystal Optical Filter

(71) Applicant: COADNA PHOTONICS INC., Sunnyvale, CA (US)

(72) Inventors: Fenghua Li, Cupertino, CA (US); Xiaokang Shen, San Jose, CA (US); Jack R. Kelly, San Jose, CA (US)

(73) Assignee: COADNA PHOTONICS INC., Sunnyvale, CA (US)

(21) Appl. No.: 13/662,191

(22) Filed: Oct. 26, 2012

Related U.S. Application Data
(60) Provisional application No. 61/551,904, filed on Oct. 26, 2011.

(51) Int. Cl. G02F 1/1335

(52) U.S. Cl. CPC G02F 1/133514
USPC 349/97

(57) ABSTRACT

An optical wavelength filter with flat-top pass-band and tunable center wavelength is presented. The filter uses birefringence wave plates, polarizers, and electrically controlled birefringent (ECB) liquid crystal cells. The filter employs a multistage structure which is composed of a cascade of filter units. Each stage includes two polarizers, two birefringent crystal wave plates and two ECB liquid crystal cells. The pair of the thinnest wave plates have a thickness of L, and the wave plates in the following stages have thicknesses of 2 L, 4 L, . . . , 2^{(N-1)}L. The passband bandwidth is determined by the free spectral range (FSR) of the filter stage with the thickest wave plates (with a thickness of 2^{(N-1)}L). The ECB liquid crystal cells enable the selection of one wavelength in a certain wavelength range and the correction of the variations in retardations which are typically caused by the variation in crystals' lengths. The flat-top liquid crystal filter has a larger 0.5-dB bandwidth as compared with classical Lyot and Solc type filters. The feature of flat-top passband is important for applications in optical network and optical communications. It also has numerous applications in optical instrumentations.

### CROSS-REFERENCE TO RELATED APPLICATION

This application claims priority to U.S. Provisional Patent Application 61/551,904, filed Oct. 26, 2011 and entitled “Tunable Flat-Top Liquid Crystal Optical Filter”, the contents of which are incorporated herein.

### BRIEF DESCRIPTION OF THE INVENTION

The present invention relates generally to optics, fiber optics, and optical communications. More particularly, the present invention relates to filtering of optical signals through the use of birefringent crystal wave plates, polarizers, and Electrically Controlled Birefringence (ECB) liquid crystal cells.

### BACKGROUND OF THE INVENTION

The present invention generally relates to optical filters, and more particularly to an optical filter assembly with a tunable center wavelength and a flat-topped passband.

### DESCRIPTION OF THE RELATED ART

With the increasing demands of multimedia applications, optical communication systems are replacing copper cable communications systems in the long-haul telecommunication systems, as well as in regional and metropolitan systems. To increase the information capacity of an optical fiber, Wavelength Division Multiplexing (WDM) and dense WDM (DWDM) have become the state-of-the-art technology in optical communications, which employs simultaneous transmission of optical signals from many different light sources with spaced peak wavelengths. To multiplex and demultiplex the optical signals, various optical components have been employed. Optical couplers can be used to combine different optical signals as a multiplexer. Optical filters can be used to separate the optical signals. Interference filters can provide a comb of multiple wavelengths, which can be placed on an ITU (International Telecommunications Union) grid for WDM or DWDM applications or be used to provide devices for fiber to the home (FTTH). Optical filters can also be used in combination with Wavelength Selective Switching (WSS) devices in Reconfigurable Optical Add-Drop Multiplexer (ROADM) networks.

Generally, there are two types of filters—adsorption filters and interference filters. In optical communications, only interference filters are of interest. A Fabry-Perot type interference filter is one type of filter which typically uses two parallel highly reflective mirrors. Another type of interference filter is a polarization interference filter, which typically uses birefringence and polarizations, such as Lyot and Solc filters. The Lyot filter is named after its inventor, Bernard Lyot. A Lyot filter consists of a cascade of filter stages, and each stage consists of two polarizers and one wave plate. In a one-stage Lyot filter, the first polarizer is oriented 45° to the fast and slow axes of the wave plate, and the second polarizer is aligned parallel to the first one. In multistage Lyot filters, the first stage has the thinnest wave plate, and each successive wave plate has twice the length of the preceding wave plate. A Multistage Lyot filter provides the properties of high spectral resolution and large dynamic range.

In multistage Lyot filters, the polarizers between adjacent stages can be shared, and typically there will be (N+1) polarizers in an N-stage filter. In contrast, a Solc filter, which was first introduced by I. Solc in 1953, only uses two polarizers. A Solc filter has a narrow transmission profile. A Solc filter is constructed from a number of birefringent crystals of the same thickness and is arranged in series. In Solc filters, the wave plates are typically stacked in either a “fan” arrangement or a “folded” arrangement, with an entrance polarizer at one end and an exit polarizer at the other end of the stack. In the “fan” architecture, the wave plates are stacked with the orientations of the optic axes of successive crystals varying from the orientation of the optic axis of the entrance polarizer by the angles α, 3α, 5α, . . . , (2n−1)α, respectively, where α=45°/n, and n is the number of crystals in the series. The optic axes of the entrance and exit polarizers in the “fan” architecture are aligned parallel to each other at 0°. In the “folded” architecture, the individual crystals are oriented alternately in succession at +α and −α with respect to the orientation of the optic axis of the entrance polarizer at 0°, and the optic axis of the exit polarizer is oriented at 90°. Making use of Jones Matrix calculus and Chebyshev's identity, the expression for the transmittance of the “folded” Solc filter can be given by,

$$T = {\vert tan ( 2 α ) cos ( χ ) \frac{sin ( n χ )}{sin ( χ )} \vert}^{2} \qquad ( Eq . 1 )$$

where χ is defined through the equation,

cos(χ)=cos(2α)sin(Γ/2) (Eq. 2)

Γ is the retardation of one waveplate at the wavelength evaluated. Generally, Solc filters are designed to obtain narrower line profiles than Lyot filters. The transmitted line will get narrower and narrower as the number of crystals n in the Solc filter increases.

There are different methods to improve the filter properties. People have introduced methods to reduce side lobes of multistage Lyot filters by using hybrid Lyot and Solc filters. Tunable birefringent filters have been built using liquid crystal elements so that the center wavelength can be dynamically selected from within a tuning range. Liquid crystals are fluids that derive their anisotropic physical properties from the long-range orientation order of their constituent molecules. The ECB liquid crystal cells uses the applied voltage to change the tilt of the liquid crystal molecules, thus to change the birefringence. In optical communications, “flat-top” passband are usually required, which is difficult for Fabry-Perot type filters.

### SUMMARY OF THE INVENTION

In one aspect, the invention involves an optical filter assembly having a flat-topped passband. The filter assembly has a cascade of filter units. One filter stage unit includes an entrance polarizer, a first wave plate and a first ECB liquid crystal cell, a second wave plate, which is identical to the first wave plate but with a different optic axis angle and a second ECB liquid crystal cell, and an exit polarizer. Two successive filter stages in series may share one entrance/exit polarizer. The free spectral range (FSR), which may be chosen equal to the channel spacing in optical communication, is determined by the filter stage with the longest wave plates. The filter stages are stacked in a way similar to a Lyot filter. The first stage has the thinnest wave plates, and the wave plates of the successive filter stages have twice the length of the preceding wave plates. By using the multistage architecture, only one wavelength in a certain wavelength range can be selected. It can be alternatively used as a multi-channel filter which produces flat-top pass bands at multiple wavelengths within a wavelength range by using fewer stages.

In another aspect, the invention provides a filter with a tunable center wavelength in a certain wavelength range through the incorporation of ECB liquid crystal cells. The ECB liquid crystal cells can apply additional retardances in addition to the wave plates, and the transmitted center wavelength can be shifted by tuning the voltages applied to the ECB liquid crystal cells.

In another aspect, the invention involves a method of filtering light. The methods includes providing a flat-top transmission spectrum, providing reduced side lobes of the spectrum, and providing tuning of center wavelength within a specific wavelength range. In optical communications, the reduction of side lobes can improve contrast ratio of adjacent channels, and can provide better channel isolations.

Other objects and features of the present invention will become apparent from the following detailed description considered in conjunction with the accompanying drawings. It is to be understood that the drawings are solely for purposes of illustration and not as a definition of the limits of the invention, for which references should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE FIGURES

The invention is more fully appreciated in connection with the following detailed description taken in conjunction with the accompanying drawing, in which:

FIG. 1 shows the transmitted spectrum and the reflected spectrum of a classical Solc filter with n=2.

FIG. 2 is a schematic diagram of the basic filter unit of the tunable flat-top optical filter.

FIG. 3 illustrates the experimental transmission curve vs. the theoretical calculated curve for one filter stage with FSR of 200 GHz.

FIG. 4 shows the schematic structure of a multistage flat-top filter.

FIGS. 5A, 5B, 5C and 5D show the transmission spectra of 5A the 7^{th} (longest) stage flat-top filter, 5B the 6^{th} stage flat-top filter, 5C the two-stage flat-top filter, 5D the 5^{th} stage flat-top filter and the three-stage flat-top filter.

FIG. 6 shows the transmission spectrum of a 7-stage flat-top filter, which has one transmission peak in the C-band.

FIG. 7 shows the schematic structure of an iterative multistage flat-top filter, in which the second longest stage is repeated, and a pair of reflective mirrors make the beam go through the filter two times.

FIGS. 8A and 8B show the transmission spectrum of an iterative 7-stage flat-top filter.

### DETAILED DESCRIPTION OF THE INVENTION

In this invention, a new type of hybrid Lyot-Solc filter is introduced. The transmission profile of the filter is compared with the classical Lyot and Solc filters. A tunable flat-top filter with a free spectral range (FSR) of 100 GHz is presented as an example. The transmission center wavelength is tunable in the C-band, or in wavelength from 1525 nm to 1565 nm. In addition, the FSR and the center wavelength are not limited to 100 GHz and the C-band, and they could be adjusted based on different requirements by changing the thickness of the wave plates and the crystal angles for various applications in optical network and optical instrumentations.

The present invention provides a multistage filter that has a tunable center-wavelength and flat-top transmission pass bands. The embodiment of the flat-top feature is realized by Solc-type filters. The ECB liquid crystal cells play an important role in tuning the transmission center wavelength and correction of the variations in the retardations of wave plates. The multistage filter employs a structure similar to a Lyot filter, and is made up of a cascade of filter units, which provides selection of a single wavelength in a certain wavelength range.

An embodiment of the flat-top transmission passband uses a classical Solc-type filter. Generally, Solc filters are designed to obtain narrower line profiles than Lyot filters. The expression for the transmittance of Eq-1 for a n=2 “folded” Solc filter can be simplified as,

$${T}_{Solc} = {sin}^{4} ( \frac{Γ}{2} ) \qquad ( Eq . 3 )$$

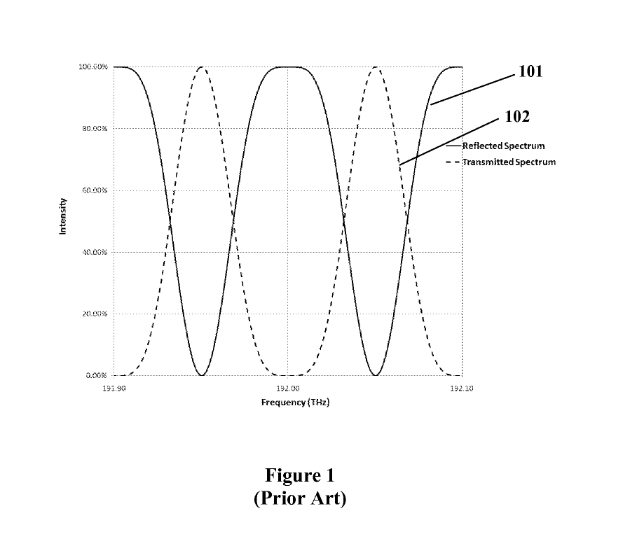

As shown in FIG. 1, the transmitted 102 and reflected 101 curves of a “folded” Solc filter with n=2 have been illustrated. The transmitted spectrum 102 has narrow transmitted lines and a flat-bottom in the stop band, while the reflected spectrum 101 has a flat-top transmittance. In one embodiment, a classical Solc filter with n=2 is used in a reverse way, i.e., the reflected spectrum is used instead of the transmitted spectrum. To use its reflected curve, the direction of exit polarizer is rotated by 90°. The Solc filter with n=2 has two birefringent crystals with the optic axes either in a “fan” or a “folded” arrangement configuration. To simplify the filter configuration, the “folded” configuration is employed. Thus, the pair of wave plates in one stage can be exactly identical in length and optic axis, and the second waveplate is turned around. The polarization directions of the entrance and exit polarizers are parallel. Therefore, the expression for a one-stage flat-top filter can be given by,

$$T = 1 - {sin}^{4} ( \frac{Γ}{2} ) \qquad ( Eq . 4 )$$

The transmitted spectrum has a flat-top feature, while the reflected spectrum has a narrow line profile. The 0.5-dB bandwidth is significantly larger than that of Lyot filter with the same FSR.

The invention further provides for filters with a dynamically tunable center wavelength in a certain spectral range. In one embodiment, the ECB liquid crystal cells are used for the fine tuning of a central wavelength in a given wavelength range. A filter in the C-band will be given as an example. The FSR of the filter is specifically chosen equal to the channel spacing. For 100 GHz channel spacing, there are 48 channels in the C-band. For the multistage filter, the filter stage unit with the largest retardation of the wave plate determines the FSR, and every additional stage knocks off the adjacent transmission peaks. To select one wavelength in the C-band, 7 stages are needed (2⁽⁷⁻¹⁾=64). By adjusting the retardation of ECB liquid crystal cells in each stage, the transmitted center wavelength can be tuned in the C-band. The optic axis of the ECB liquid crystal cell is aligned parallel to the attached wave plate.

An embodiment for the reduction of side lobes of the transmission profile lets the signal go through the filter multiple times. For example, a pair of mirrors may be used to reflect the optical beam back and forth two or more times. The contrast ratio of adjacent channels is significantly improved by the reduction of side lobes.

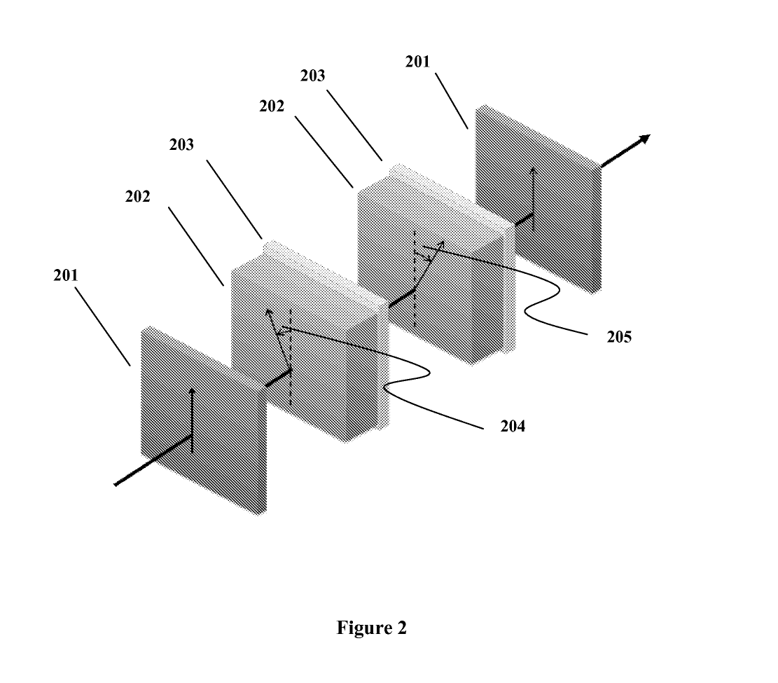

FIG. 2 illustrates a schematic diagram of one filter stage unit. A light beam (i.e., optical radiation of any spectral range of interest, including the ultraviolet, visible, and infrared; in optical communications, it can be from a broadband SLED) passes normally through a polarizer 201, which has a polarization direction as shown in the figure (in the figure the polarization direction is selected as the vertical direction for convenience). The polarizer can be a beam displacer (BD), which can change the input beam to two parallel beams with orthogonal polarization directions and without significant loss in light intensity. The beam becomes a linear polarized light after the polarizer. Then the beam passes through a wave plate 202 with an optic axis 204 at +22.5° with respect to the first polarizer direction. Depending on the length of the waveplate, the light beam with polarization components along extraordinary axis (optic axis) and ordinary axis (perpendicular to the optic axis) emerge in a different polarization state, which can be characterized by the retardance, Γ. After the wave plate 202, there is an ECB liquid crystal cell 203 with an optic axis at the direction the same as the birefringent crystal. The ECB liquid crystal cell 203 can be used to correct the variation in the retardance of the wave plates caused by the variance of the crystal length, and it can also be used to tune the center wavelength of the passband. Then the light beam passes through a second wave plate 202, which has an identical length as the first wave plate with an optic axis 205 at −22.5° with respect to the first polarizer direction. The second wave plate 202 is accompanied by another ECB liquid crystal cell 203. After the pair of wave plates and ECB liquid crystal cells, the light beam passes through another linear polarization analyzer 201, which is oriented at the same direction as the entrance polarizer. The analyzer analyzes the polarization of the light beam to produce an overall filter effect.

A wave plate (or retarder) is an optical device that alters the polarization state of a light wave travelling through it. In general, it can be a layer of birefringent material, including without limitation quartz, calcite, lithium niobate (LiNbO₃), yttrium vanadate (YVO₄), stretched polymers, sapphire, beta barium borate (β-BaB₂O₄, BBO), liquid crystals, liquid crystal polymers, etc. Birefringent crystal wave plate can be fabricated using standard optical techniques from the raw optical-grade crystals. In an embodiment, the wave plates used are made of YVO₄ crystals. The FSR in frequency of the filter is given by the following equation,

$$F S R = \frac{c}{( {n}_{e} - {n}_{o} ) L} = \frac{c}{Δ nL} \qquad ( Eq . 5 )$$

where c is the speed of light, nₒ is the ordinary refractive index, nₑ is the extraordinary index, Δn is the birefringence (for a YVO₄ crystal at a wavelength around 1.55 μm, Δn≈0.2039), and L is the length of the YVO₄ crystal wave plate. For 100 GHz channel spacing in a wavelength range from 1525 nm to 1565 nm (the C-band), the FSR is chosen as 100 GHz, and the crystal length is around 14.2 mm. The retardance Γ in angular frequency can be obtained by the following equation,

$$Γ = \frac{2 πΔ nL}{λ} \qquad ( Eq . 6 )$$

where λ is the vacuum frequency at which the frequency is being evaluated. As can be seen from Eq. 6, the retardance is a function of wavelength, which causes the interference effect.

According to Eq. 4, 5, and 6, the expression for the transmittance can be simplified as follows:

$$T = 1 - {sin}^{4} ( \frac{π v}{F S R} ) \qquad ( Eq . 7 )$$

where v is the frequency of the light, and FSR is a constant for the specific filter stage. Eq. 7 is a periodic function of frequency v with a period of FSR.

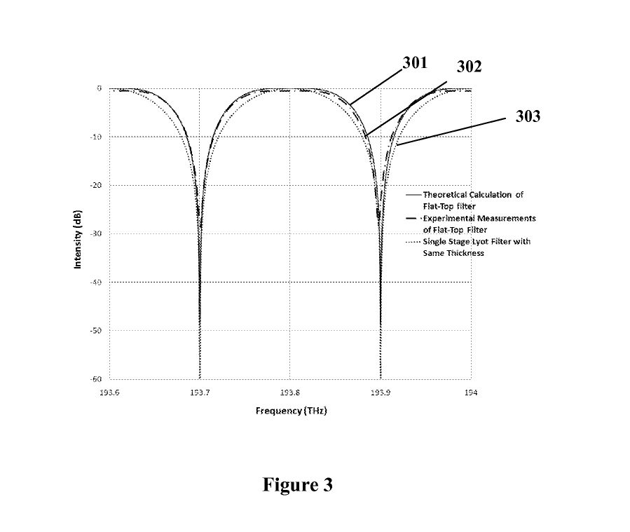

FIG. 3 shows the transmission spectrum of one filter stage with FSR of 200 GHz and the theoretic calculated spectrum. YVO₄ crystal wave plates with a length of 7.1 mm have been used in this measurement. The wave plates and the polarizers are placed as shown in FIG.2, in a “folded” arrangement. There is no ECB liquid crystal cell used in this measurement. As can be seen from the figure, it shows good agreement between the measurements 302 and the theoretical calculated transmission curves 301. The theoretical calculation 303 on the single stage Lyot filter with single wave plate with the same thickness is also shown in the figure for comparison, which does not have a flat top passband. The passband bandwidths for a one-stage flat-top filter are measured and calculated, respectively, as shown in Table. 1. There is a small difference between the theoretical value and the measured value, which is attributed to the variation in the waveplate thickness. The passband bandwidths for a single Lyot filter with the same thickness have been calculated and listed in Table 1. As can be seen, the flat-top filter has a larger bandwidth than the Lyot filter.

TABLE 1
Passband bandwidths of one-stage flat-top filter
with a FSR of 200 GHz (theoretical and measured results)
and one-stage Lyot filter with same FSR.

| | | Theoretical | Measured | Theoretical |
|---|---|---|---|---|
| | | bandwidth of flat- | bandwidth of flat- | bandwidth of Lyot |
| | | top filter (GHz) | top filter (GHz) | Filter (GHz) |
| 0.5 | dB | 78 | 77 | 42.5 |
| 3 | dB | 127 | 126 | 99.5 |
| 10 | dB | 171 | 170 | 159.5 |

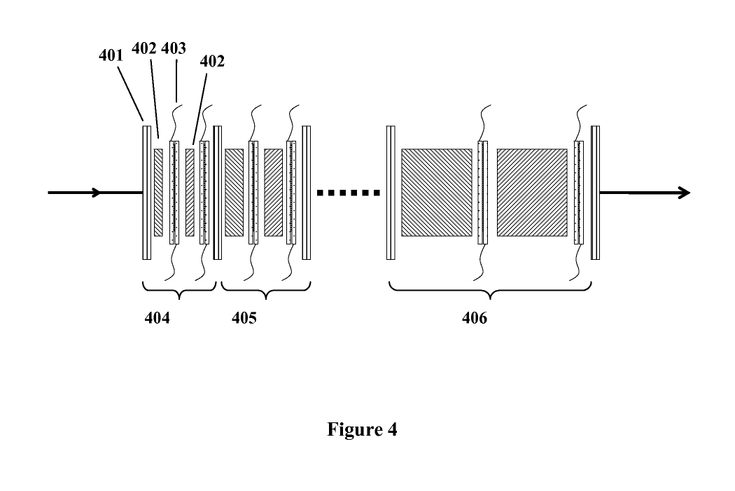

The structure of the multistage filter, with stages 404, 405 and 406, is illustrated in FIG. 4. The first filter stage 404 includes a polarizer 401, a first waveplate 402, a liquid crystal cell 403 and a second waveplate 402. The thinnest wave plates 402 determines the spectral range in which only one wavelength can be selected. To select one wavelength in the C-band (from 191.0 THz to 196.5 THz), the first filter stage must have a FSR greater than the C-band frequency coverage (i.e. 5.5 THz). In today's optical communications, 100 GHz and 50 GHz channel spacing in the C-band are typically used. For selection of only one channel with 100 GHz channel spacing in the C-band, the thinnest wave plates will have a FSR of 6.4 THz (2^{7.1}=64 times 100 GHz), and 7 stages are used. When using YVO₄ crystals, the thinnest wave plates have a length of L₁≈0.2218 mm, and the thickest wave plates have a length of L₇≈14.2 mm. The k^{th} filter stage has wave plates with a thickness of Lₖ=2 Lₖ₋₁=2^{k-1}L₁, and a retardation of Γₖ=2Γₖ₋₁=2^{k-1}Γ₁. The overall transmission of an N-stage flat-top filter is given by:

$$T = {T}_{0} {\prod }_{k = 1}^{N} ( 1 - {sin}^{4} ( \frac{{Γ}_{k}}{2} ) ) = {T}_{0} {\prod }_{k = 1}^{N} ( 1 - {sin}^{4} ( \frac{π v}{( \frac{c}{Δ n {2}^{k - 1} L} )} ) ) \qquad ( Eq . 8 )$$

where T₀ represents losses due to adsorption and reflection, and

$$\frac{c}{Δ n {2}^{k - 1} L}$$

is the FSR of the k^{th} filter stage, which is also the frequency period in their transmission spectrum.

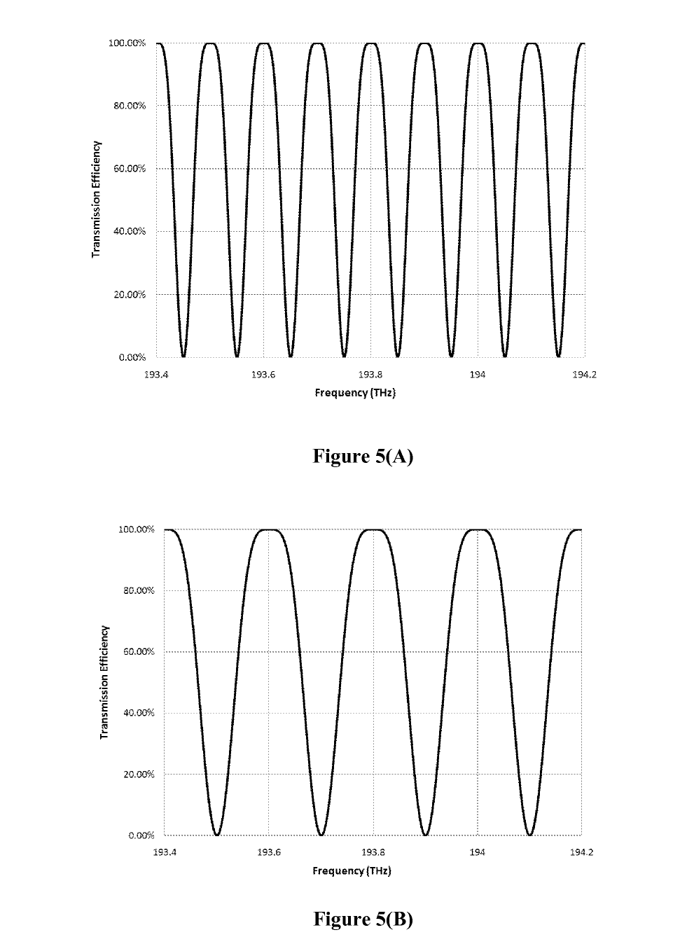

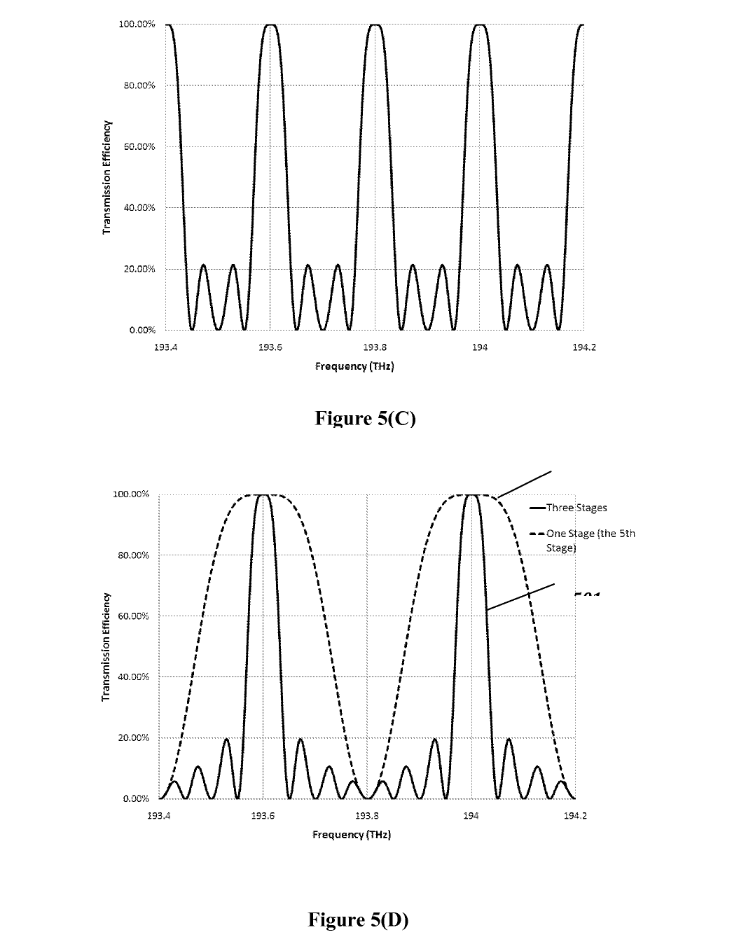

FIG. 5(a) shows the transmission spectrum for the longest stage with a FSR of 100 GHz, and FIG. 5(b) shows the transmission spectrum from the filter stage with a FSR of 200 GHz. The combined two-stage filter has a transmission spectrum as shown in FIG. 5(c). From FIG. 5(c) it can be seen that the second filter diminishes every other transmission peak of the first filter stage. Each additional stage diminishes every other one of the remaining peaks. FIG. 5(d) shows the overall transmission profile 501 of a three-stage filter which is combined with a third stage. The transmission spectrum of the third filter stage with a FSR of 400 GHz is also shown 502. Since this type of filter has a flat-top passband, the additional stages do not have much effect on the pass band bandwidth. For a one-stage filter with a FSR of 100 GHz, the theoretical 0.5-dB bandwidth is around 39 GHz, while it is 38 GHz for a 7-stage filter. The theoretical bandwidths for multistage filters have been calculated and listed in Table 2. By adding additional stages, the flat-top feature is nearly unchanged.

TABLE 2
Calculated passband bandwidths of multistage
flat-top filter with a FSR of 100 GHz.

Passband Bandwidth (GHz)

| Stage | 0.5 dB | 3 dB | 10 dB | 20 dB |
|---|---|---|---|---|
| 1 | 39 | 63.5 | 85.5 | 95.5 |
| 2 | 38 | 62 | 84 | 95 |
| 3 | 38 | 62 | 84 | 95 |
| 4 | 38 | 62 | 84 | 95 |
| 5 | 38 | 62 | 84 | 95 |
| 6 | 38 | 62 | 84 | 95 |
| 7 | 38 | 62 | 84 | 95 |

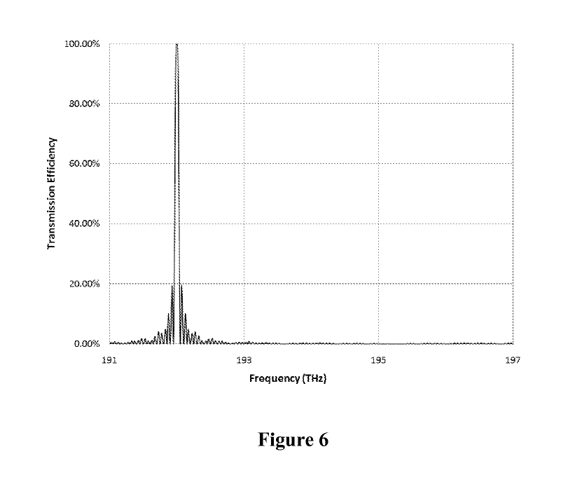

FIG. 6 shows the transmission spectrum for an ideal 7-stage filter without ECB liquid crystal tuning, which has a passband at a particular ITU frequency of f₀. In the ideal case, f₀ is equal to 192.0 THz in the C-band, which must be an integer multiple of the FSR of 6.4 THz according to the transmission equation (Eq. 8). However, this is only the “ideal” case. In real situations, there are errors in the waveplate thicknesses due to a lack of accuracy in manufacturing. Therefore, a tunable correction in retardation is added to each waveplate. In addition, to shift the transmission peak to an arbitrary ITU channel, an additional retardation phase γₖ is added to each wave plate. To shift to an adjacent 100 GHz ITU channel, the retardations are,

γₖ=±2^{k-7}π (Eq. 9)

where +/− sign corresponds to shift to a lower/higher frequency. To move to m 100 GHz channels from f₀, the retardations are,

$${y}_{k} ( m ) = m \cdot \frac{{2}^{k}}{{2}^{7}} π - n \cdot 2 π , \\ m = 0 , \pm 1 , \pm 2 , \pm 3 , … , \qquad ( Eq . 10 )$$

and n is an integer which makes 0<γₖ(m)<2π

For the 7^{th} filter (the longest), only two voltage states are needed, 0 and π; and for the 1^{st} (the thinnest) filter stage, a subset (48 channels) from 64 voltage states are needed, 0, (1/32)π, (2/32)π, . . . , (63/32)π. Tunable optical retardation can be implemented in a number of ways. In this invention, liquid crystals are used to implement this function. Liquid crystals exhibit birefringence and the optic axis can be reoriented by an electric field. By applying different voltages to each waveplate, additional retardations including both corrections of variations and the tuning of ITU channels can be applied.

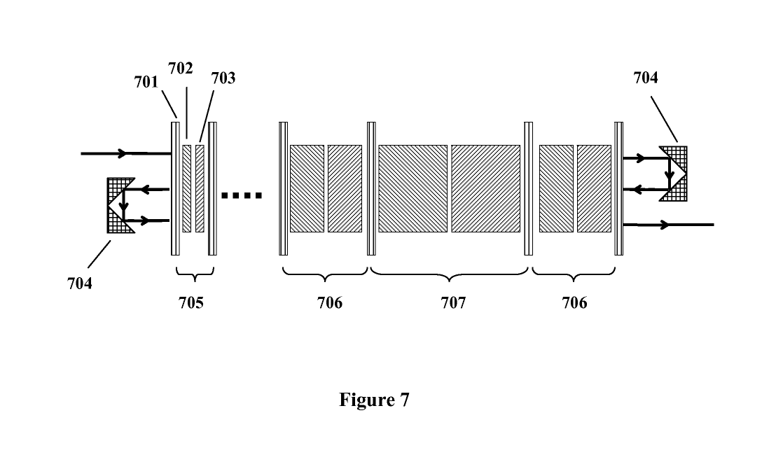

As can been in FIG. 6, there are some side lobes in the transmission spectrum. In fiber communication, these side lobes may possibly cause crosstalk in adjacent channels. To prevent these types of crosstalk, some filter stages should be repeated in order to reduce the side lobes. FIG. 7 illustrates a first stage 705, a sixth stage 706 and a seventh stage 707.

The first stage 705 and each additional stage includes a polarizer 701, waveplate and liquid crystal cell 702 (with an optical axis of +22.5°) and waveplate and liquid crystal cell 703 (with an optical axis of −22.5°). The first stage 705 has the thinnest wave plates, while the seventh stage has the longest wave plates. As shown in FIG. 7, the sixth stage 706 has been repeated, and a pair of corner roof prisms 704 have been placed at both ends of the total flat-top filter to make the beam go through the filter two more times. By taking this embodiment, the side lobes are significantly reduced.

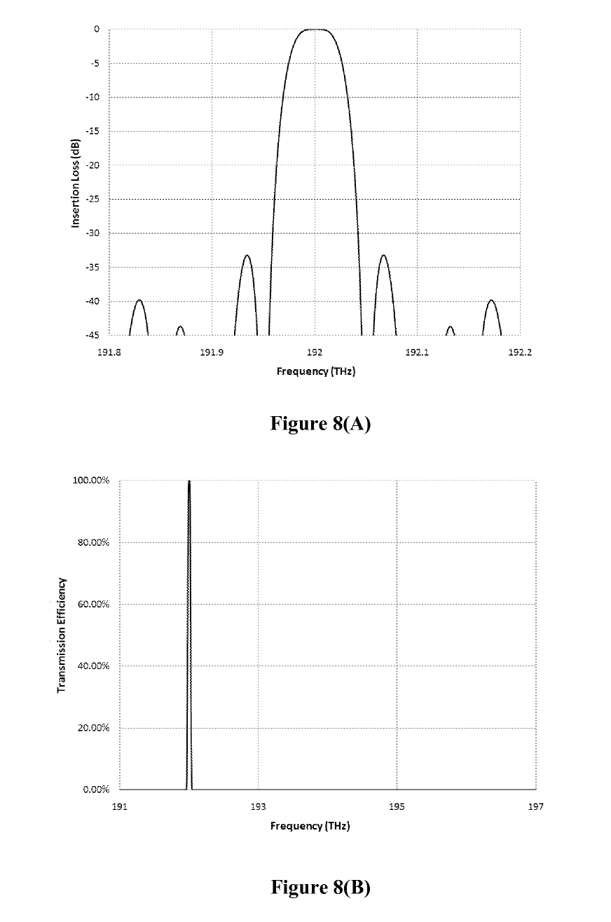

Referring to FIG. 8a, the total transmission spectrum for the iterative flat-top filter is shown. As can be seen in FIG. 8b, the side lobes have been significantly suppressed. In FIG. 8a, the side lobes are generally more than 30 dB.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An optical wavelength filter, comprising:
a multiple stage structure with a cascade of N filter units, wherein each stage includes two polarizers, two birefringent crystal wave plates and two electrically controlled birefringent liquid crystal cells, wherein the pair of the thinnest wave plates have a thickness of L, and the wave plates in the following stages have thicknesses of 2 L, 4 L, . . . , 2^{(N-1)}L.

2. The optical wavelength filter of claim 1 wherein the passband bandwidth is determined by the free spectral range of the filter stage with the thickest wave plates 2^{(N-1)}L.

3. The optical wavelength filter of claim 1 wherein the birefringent liquid crystal cells are configured for selection of a single wavelength.

4. The optical wavelength filter of claim 1 operable as a flat-top pass-band filter.

5. The optical wavelength filter of claim 1 operable as a tunable center wavelength filter.

6. The optical wavelength filter of claim 1 further comprising a pair of mirrors to reflect an optical beam back and forth two or more times for the reduction of side lobes.

7. The optical wavelength filter of claim 1 wherein the birefringent crystal wave plates each includes an additional retardation phase to a signal shift transmission peak.

8. The optical wavelength filter of claim 1 wherein the birefringent crystal wave plates receive control voltages for retardation control.
